(19) United States
(12) Patent Application Publication
(10) Pub. No.: US 2024/0395455 A1
(43) Pub. Date: Nov. 28, 2024

(54) ELECROMAGNETIC COMPONENT WITH REDUCED PARASITIC CAPACITANCE INDUCED LOSS

(71) Applicant: Resonant Link, Inc., South Burlington, VT (US)

(72) Inventors: Aaron Stein, Essex, VT (US); Panteleimon Papamanolis, Zurich (CH); Yi Dou, Gentofte (DK); Phyo Aung Kyaw, Winooski, VT (US)

(73) Assignee: Resonant Link, Inc., South Burlington, VT (US)

(21) Appl. No.: 18/792,926

(22) Filed: Aug. 2, 2024

Related U.S. Application Data
(63) Continuation-in-part of application No. 18/418,979, filed on Jan. 22, 2024.
Application No. 18/418,979 is a continuation of application No. PCT/US2022/038179, filed on Jul. 25, 2022.
(60) Provisional application No. 63/226,022, filed on Jul. 27, 2021.
(60) Provisional application No. 63/517,391, filed on Aug. 3, 2023.

(51) Int. Cl. H01F 27/34; H01F 27/24; H01F 27/28

(52) U.S. Cl. CPC H01F 27/341; H01F 27/24; H01F 27/2823

(57) ABSTRACT

An electromagnetic component includes a winding and a plurality of distributed winding capacitances in series with the winding at respective locations along the winding.

### RELATED APPLICATIONS

This application claims the benefit under 35 U.S.C. § 119(e) of the filing date of U.S. Provisional Application Ser. No. 63/517,391, filed Aug. 3, 2023, and is a Continuation-in-Part of U.S. Nonprovisional application Ser. No. 18/418,979, filed Jan. 22, 2024, which is a Continuation of International Patent Application Serial No. PCT/US2022/038179, filed Jul. 25, 2022, which claims the benefit under 35 U.S.C. § 119(e) of U.S. Provisional Application Ser. No. 63/226,022, filed Jul. 27, 2021. The entire contents of each of the above-identified applications is hereby incorporated by reference.

### BACKGROUND

### 1. Technical Field

The apparatus and techniques described herein relate to reducing loss induced by parasitic capacitance in electromagnetic components.

### 2. Discussion of the Related Art

Electromagnetic components, such as inductors, transformers, and wireless power transfer coils may include one or more windings formed of electrical conductors. Parasitic capacitance excited between turns of the one or more windings may lead to power losses and reduced quality factor.

### SUMMARY

Some aspects relate to an electromagnetic component, comprising: a winding; and a plurality of distributed winding capacitances in series with the winding at respective locations along the winding. The foregoing summary is provided by way of illusion and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1A illustrates an example of an electromagnetic component with a winding that includes a thin-layer conductor having a single turn.

FIG. 1B illustrates an example of an electromagnetic component with a winding that includes a thin-layer conductor having a plurality of turns.

FIG. 2A illustrates an example of an electromagnetic component with turn-to-turn parasitic capacitance.

FIG. 2B illustrates an example of an electromagnetic component with return-lead parasitic capacitance.

FIGS. 3A and 3B illustrate an example of how the voltage of a winding increases linearly along the winding.

FIG. 4A illustrates an example of a three-turn winding in which each turn includes a distributed winding capacitance formed by one or more standalone capacitors, according to some embodiments.

FIG. 4B illustrates an example of a three-turn winding in which each turn includes two distributed winding capacitances located 180 degrees apart from one another, according to some embodiments.

FIG. 5 illustrates an example of how distributing the capacitance along the winding as shown in FIG. 4A modifies the voltage along the winding with respect to the examples of FIGS. 3A and 3B, according to some embodiments.

FIG. 6A illustrates an example of a partial cross-sectional view of the winding in which a single resonant capacitor is connected in series with the winding, according to some embodiments.

FIG. 6B illustrates an example of a partial cross-sectional view of the winding in which the resonant capacitance is distributed between the four layers, according to some embodiments.

FIG. 7 shows an example of an electromagnetic component having a two-turn wire winding in which each turn includes a distributed winding capacitance formed by one or more standalone capacitors, according to some embodiments.

### DETAILED DESCRIPTION

The inventors have developed at least one improvement to electromagnetic components, and in particular a reduction in the effect of parasitic capacitance.

As mentioned above, electromagnetic components, such as inductors, transformers, and wireless power transfer coils may include one or more windings formed of electrical conductors. The electrical conductors (also referred to herein as conductors) may be wire, magnet wire, stranded wire, litz wire, printed circuit board traces, conductors laminated on a substrate, foil layers, electrode layers in multilayer ceramic capacitor (MLCC) processes, electrode layers in low-temperature co-fired ceramic (LTCC) processes, integrated circuit traces, for example, or any combination of thereof. The electrical conductors may include any electrically conductive material or combination of materials, including but not limited to one or more metals such as silver, copper, aluminum, gold and titanium, and non-metallic materials such as graphite. The electrically conductive material may have an electrical conductivity of higher than 1 MS/m, optionally higher than 200 kS/m. The conductors may have any physical shape including, but not limited to, solid material, foil, conductors laminated on a substrate, and printed circuit board traces.

Some electromagnetic components have one or more magnetic cores. A magnetic core may be, wholly or partially, made of one or more ferromagnetic materials, which have a relative permeability of greater than 1, optionally greater than 10. The magnetic core materials may include, but are not limited to, one or more of iron, various steel alloys, cobalt, ferrites including manganese-zinc (MnZn) and/or nickel-zinc (NiZn) ferrites, nanogranular materials such as Co—Zr—O, and powdered core materials made of powders of ferromagnetic materials mixed with organic or inorganic binders. However, the techniques and devices described herein are not limited as to the particular material of the magnetic core. The shape of the magnetic core may be: a pot core, a sheet (I core), a sheet with a center post, a sheet with an outer rim, RM core, P core, PH core, PM core, PQ core, E core, EP core, or EQ core, by way of example. However, the techniques and devices described herein are not limited to the particular magnetic core shape. An electromagnetic component may comprise one or a plurality of magnetic cores, with or without an air gap in the magnetic flux path; in some embodiments, for example with open-faced pot cores, widely used for wireless power transfer, the air gap in the magnetic flux path may be substantial.

Some electromagnetic components include conductors that are thin-layer conductors (also referred to herein as thin conductor layers). Thin-layer conductors may have the advantages of having a low profile and a low cost of manufacturing compared to alternatives such as magnet-wire or litz-wire windings, for example. Thin-layer conductors may be formed in a variety of processes, and in one example may be formed from printed circuit board (PCB traces). However, the structures and techniques described herein are not limited to thin-layer conductors, and also apply to other conductors such as any of those listed above.

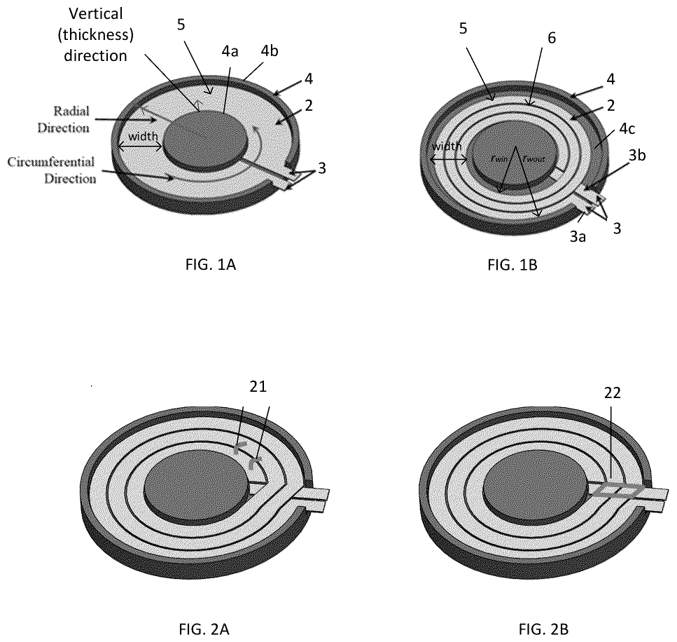

FIG. 1A shows an example of an electromagnetic component with a winding (also termed a coil) that includes a thin-layer conductor 2 having a single turn. Also illustrated in FIG. 1A are leads 3 of the winding, and a magnetic core 4. The magnetic core 4 in this example is pot core having a center post 4a and an outer rim 4b. Optionally, the magnetic core 4 may have a backplate (not shown in FIG. 1A). The thin-layer conductor 2 may be embedded between the center post 4a and an outer rim 4b in a winding region 5. The winding region 5 may span a width from center post 4a to outer rim 4b as illustrated in FIG. 1A. Also illustrated in FIG. 1A are directions relative to the electromagnetic component such as are used in a polar coordinate system, including a radial direction extending radially from the center of an imaginary circle approximating the outline of the electromagnetic component from a top view, a circumferential direction perpendicular to the radial direction at respective circumferential positions around the electromagnetic component, and a vertical (thickness) direction extending perpendicularly to the radial and circumferential directions.

FIG. 1B shows an example of an electromagnetic component with a winding that includes a thin-layer conductor 2 having a plurality of turns, specifically three turns, in this example. Each turn corresponds to one revolution of the winding about a center of the winding. The winding of FIG. 1B spirals gradually from lead 3a towards the center before returning underneath the turns of the winding as a return lead 3b. Each turn of the thin layer conductor 2 may be separated by a gap 6 in the radial direction. The gap may include any electrically non-conductive material (dielectric material) or combination of materials, including but not limited to one or more of air, FR4, PLA, ABS, polyimide, PTFE, polypropylene, Rogers Substrates, plastic, glass, alumina, ceramic, dielectric or ceramic layers in multilayer ceramic capacitor (MLCC) processes, or dielectric or ceramic layers in low-temperature co-fired ceramic (LTCC) processes, for example.

The magnetic core 4 in this example is pot core having a center post 4a and an outer rim 4b. Also visible in FIG. 1B is a backplate 4c of the magnetic core 4. The turns of the winding and the return lead 3b are electrically insulated from one another by a dielectric material (not shown). The thin-layer conductor may be disposed over backplate 4c and embedded between center post 4a and outer rim 4b within a winding region 5. The winding region 5 may span a width in the radial direction from r_{win} to r_{wout} as illustrated in FIG. 1B.

Thin-layer windings are windings of one or more thin-layer conductors. Thin layer conductors are electrical conductors in which the thickness of the winding is much smaller than its width (e.g., at least 10 times smaller). For example, the thin-layer winding shown in FIG. 1A may be formed of a conductive foil having a thickness (in the vertical direction) much smaller than its width (in the radial direction). For a thin-layer winding with a plurality of turns, the thin-layer winding has a thickness that is much smaller (e.g., at least 10 times smaller) than the width (radial extent) of all the turns in the thin-layer winding. For example, in FIG. 1B, the width of the thin-layer winding is the radial extent of the winding across all three traces, which in this case are three turns connected in series. Some examples of thin-layer conductors or their applications may include, but are not limited to, foil layers forming a flat current loop (e.g. C-shaped, arc-shaped, rectangular-shaped, or any polygon-shaped conductors); edge-wound conductors; printed circuit boards; multilayer self-resonant structures (U.S. Pat. Nos. 10,109,413 and 10,707,011, PCT/US2017/043377, patent application Ser. No. 16/994,448); inductively coupled current loops (patent application PCT/US2021/15260); multilayer conductors with integrated capacitance (patent application PCT/US2021/041387); and low-frequency resonant structure (provisional application PCT/US2021/041387), and any of the foil conductors mentioned before in which the conductor is patterned.

As illustrated in FIG. 1A and FIG. 1B, the thin-layer conductor(s) may be positioned within a winding region 5 between a center post 4a and an outer rim 4b of the magnetic core 4. However, the techniques and apparatus described herein are not limited to particular types of magnetic cores, as in some magnetic cores there may not be a center post and/or outer rim, and in some cases a magnetic core may be omitted.

Electromagnetic components may comprise a single conductor layer (as shown in FIGS. 1A and 1B) or a plurality of layers. At least one example of an electromagnetic component having a plurality of layers is discussed further below.

The inventors have recognized that a winding of an electromagnetic component has parasitic capacitance. The parasitic capacitance takes at least two forms: turn-to-turn parasitic capacitance 21, which is the capacitance between adjacent turns of the winding, as illustrated in FIG. 2A, and return-lead capacitance 22, which is the capacitance between the return lead and turn(s) of the winding, as illustrated in FIG. 2B. In the example of FIG. 2B, the return lead extends from the interior of the electromagnetic component under the turns of the winding. The return-lead capacitance 22 forms in the overlap area where the turns extend over the return lead.

The inventors have appreciated that the impact of parasitic capacitance on power loss is larger when the winding has a larger number of turns and when the winding includes more than one layer of turns. Larger impact of parasitic capacitance results in the electromagnetic component having a lower self-resonant frequency, decreased effective inductance, and increased equivalent series resistance (ESR). The increase in ESR corresponds to a lower quality factor (Q). The reduction in Q can be more significant when a low performance dielectric (e.g., FR4 or polyimide PCB layers) is present.

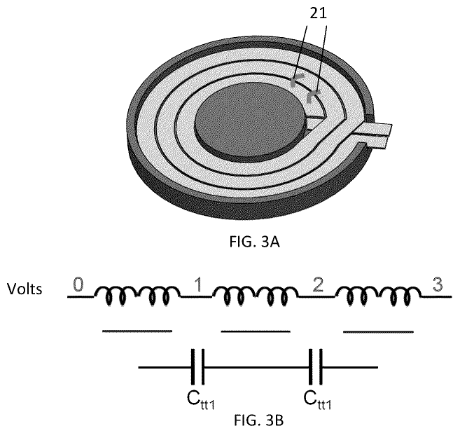

FIGS. 3A and 3B illustrate an example of how the voltage of a winding increases linearly along the winding. In this example the winding (FIG. 3A) has three turns, with the voltage of a first terminal being at zero volts, the voltage after one turn is 1 volt, the voltage after two turns is 2 volts, and the voltage after three turns (the return lead voltage) is three volts (FIG. 3B). The inventors have appreciated that when different turns are at different voltages, an electric field exists across the turns, which increases the loss caused by the parasitic capacitance between the turns.

Conventional windings (coils) are constructed from one or more turns of an electrically conductive material wrapped into an inductive current loop with two ends (terminals). In a conventional winding, a capacitor may be connected to one or both terminals of the winding which may provide a resonant capacitance.

In some embodiments, the resonant capacitance may be distributed into a plurality of capacitances connected in series with respective turns of the coil. A capacitance connected in series with a turn of a coil is also termed herein a distributed winding capacitance. The capacitance value of the distributed winding capacitance may be selected to cancel or approximately cancel the inductive impedance of the turn (or portion of the turn, or more than one turn) with which the capacitor is connected in series. However, the techniques and apparatus described herein are not limited to exact cancellation. Partial or extra cancellation can be useful (e.g., capacitive reactance is 50% to 200% the inductive reactance of the turn). In wireless power transfer, or other resonant power conversion applications, the distributed winding capacitance value can be chosen to resonate with the inductance of one or more turns, which provides the resonance used for wireless power transfer or power conversion.

Distributing some or all of the resonant capacitance into a plurality of capacitances in series with the turns of a series resonant coil may reduce loss in the circuits, winding, and leads. Distribution of the resonant capacitance into one or more turns as a distributed winding capacitance reduces the voltage (electrical potential difference) between each turn, or between the turns and the return current path, and therefore reduces by any amount or eliminates the excitation of parasitic capacitances. In some embodiments, capacitive devices having a lower voltage rating may be used for a capacitance in series with each turn as opposed to providing a single resonant capacitance for the entire coil. Distributed winding capacitances reduce the voltage difference between portions of the coil, which reduces the need to design for high voltages (e.g., with thicker insulation). Distributed winding capacitances may enable higher power operation by distributing heat generation more uniformly within the coil. Distributed winding capacitances may enable operation of a larger frequency range and bandwidth.

In some embodiments, a distributed winding capacitance may be included for each and every turn of the coil and/or each and every layer of the coil, which may provide high performance. However, the apparatus and techniques described herein are not limited in this respect, as a distributed winding capacitance may be provided corresponding to any one or more turns of the coil and/or any one or more layers of the coil.

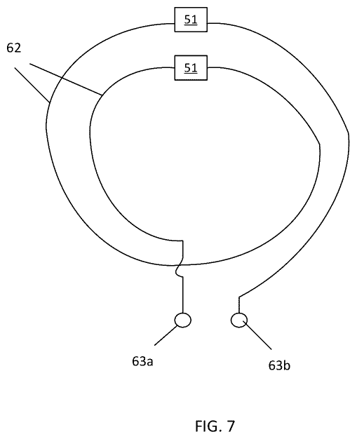

A distributed winding capacitance may be provided by a variety of capacitive devices, such as standalone capacitors or integrated capacitors, for example. Standalone capacitors may be formed by any of a variety of devices. Standalone capacitors are devices with dominant capacitive (negative reactive) impedance at the desired frequency of operation; they may have inductive (positive reactive) impedance less than the capacitive impedance at the frequency of operation, and optionally less than 20% of the capacitive impedance at the frequency of operation. In some embodiments, the one or more standalone capacitors are discrete capacitors. The standalone capacitor(s) may have individual packaging which can be galvanically connected to electrical conductors (e.g., by soldering). The standalone capacitor(s) may include, but are not limited to one or more of ceramic capacitors, multilayer ceramic capacitors (MLCCs), film capacitors, mica capacitors, PTFE capacitors, tantalum capacitors, tantalum-polymer capacitors, thin film capacitors, electric double layer capacitors, polymer capacitors, electrolytic capacitors, niobium oxide capacitors, silicon capacitors, variable capacitors, and any combination, network or array of devices. In some embodiments, a distributed winding capacitance may include an integrated capacitance, which may be a capacitance between adjacent conductors of the winding in different layers, as illustrated in FIGS. 7 and 8A-8D of PCT application PCT/US2022/038179, by way of example.

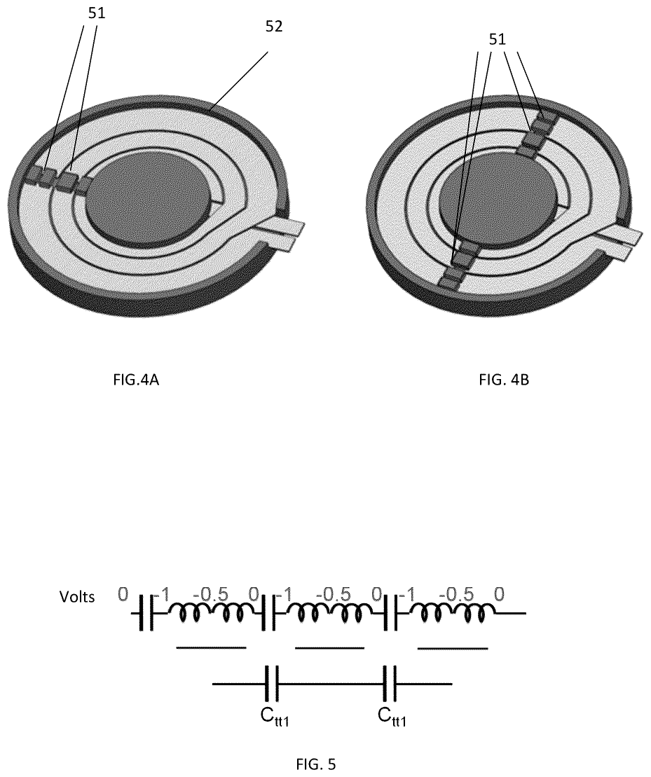

Examples of coils including distributed winding capacitances formed by standalone capacitors are shown in FIGS. 4A and 4B. FIG. 4A shows a three-turn winding formed of thin conductor layers, in which each turn includes a distributed winding capacitance 51 formed by one or more standalone capacitors. In this example, a single distributed winding capacitance 51 is located 50% of the way through each turn, 180 degrees away from the two terminals 3. Distributing the capacitance along the winding modifies the voltage along the winding as shown in FIG. 5, effectively reducing eliminating the effect of parasitic capacitance. However, the distributed winding capacitance 51 need not be located at this position, and need not be limited to a single distributed winding capacitance for a turn.

In some embodiments, providing more than one distributed winding capacitance for a turn may improve thermal distribution. When more than one distributed winding capacitance is included for a turn, the one or more distributed winding capacitances may be separated by a portion of the conductor. FIG. 4B shows an example in which each turn includes two distributed winding capacitances 51 located 180 degrees apart from one another. A first distributed winding capacitance 51 is located 25% of the way through each turn, and a second distributed winding capacitance 51 is located 75% of the way through each turn. Each turn includes two distributed winding capacitances 51 formed by one or more standalone capacitors. However, the number of distributed winding capacitances for a turn is not limed to two, as any number of distributed winding capacitances may be included. The distributed winding capacitances need not be 180 degrees apart from one another, and can be anywhere along the winding. Distributing the capacitance along the winding modifies the voltage along the winding, effectively reducing the voltage by any amount or eliminating the effect of parasitic capacitance.

FIG. 5 shows distributing the capacitance along the winding as shown in FIG. 4A modifies the voltage along the winding with respect to the example of FIGS. 3A and 3B. In this example, the reactances of the series capacitors and inductors cancel out, such that the voltage difference between adjacent turns at the same circumferential position is zero, which avoids the effect of parasitic capacitance between the turns. However, this is an example, and the techniques and structures described herein may be used to reduce the effect of parasitic capacitance by any amount.

In some embodiments, a winding may be formed in a single layer or in a plurality of layers with insulating material between the layers.

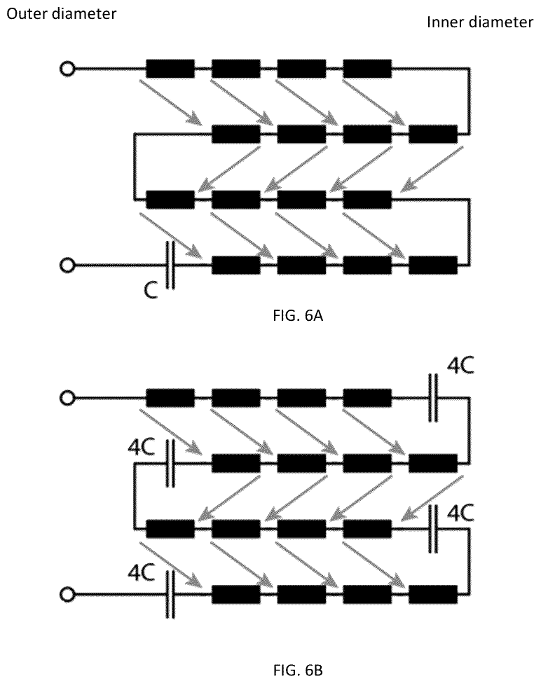

FIGS. 6A and 6B show an example in which a winding is formed in a plurality of layers. FIGS. 6A and 6B show a partial cross-sectional view of the winding between its inner and outer diameter. In this example, a winding is formed in four layers, and all four layers are connected in series, with all turns in each layer being connected in series with one another. FIG. 6A shows an example in which a single resonant capacitor is connected in series with the winding. In such a design, the voltage of the turns varies both within a layer and from layer to layer, which allows parasitic capacitance to have a significant effect.

FIG. 6B shows an example in which the resonant capacitance is distributed between the four layers, with one capacitance per layer. The introduction of a distributed capacitance in such a manner allows the voltage difference between the turns in different layers to be reduced, thus reducing the effect of the parasitic capacitance between turns in different layers. However, this is an example, and the techniques described herein are not limited to a winding having a particular number of layers, or to a particular distribution of capacitance. For example, there may be more than one capacitance per layer, with a capacitance separating respective turns within a layer. As another example, there may be fewer than one capacitance per layer. For example, there may be one distributed winding capacitance for every two layers, every three layers, etc. More generally, the capacitances may be distributed in such a manner that not every turn has its own distributed capacitance, as in the examples of FIG. 4A and FIG. 4B.

The electromagnetic components described herein are not limited to including thin-layer conductors. FIG. 7 shows an example of a winding formed of wire 62, in which each turn includes a distributed winding capacitance 51 formed by one or more standalone capacitors. In this example, the winding includes only two turns. However, this is an example, and the winding may include any number of two or more turns, having one or more distributed winding capacitances per turn, or fewer than one distributed winding capacitance per turn (e.g., one distributed winding capacitance per N turns, where N is more than one). Distributing the capacitance along the winding modifies the voltage along the winding, effectively reducing the voltage, and reduces or eliminates the effect of parasitic capacitance. The wire 62 may include, but is not limited to, magnet wire, stranded wire, litz wire, for example, or any combination of thereof. In this example a single distributed winding capacitance 51 is located 50% of the way through each turn, 180 degrees away from the two terminals. However, the distributed winding capacitance 51 need not be located at this position, and need not be limited to a single distributed winding capacitance for a turn. In some embodiments, providing more than one distributed winding capacitance for a turn may improve thermal distribution, as mentioned above. Any number of distributed winding capacitances may be included. When more than one distributed winding capacitance is included for a turn, the more than one distributed winding capacitances may be separated from each other by a portion of the conductor. Alternatively or additionally, a distributed winding capacitance may be provided for more than one turn, as in the example of FIG. 6B. That is, a distributed winding capacitance may be in series with a plurality of turns, followed by another distributed winding capacitance, followed by a plurality of turns, etc., in series with one anther. Wires 62 may be connected to respective terminals of distributed winding capacitances in any suitable manner (e.g., soldering).

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “substantially,” “approximately,” “about” and the like refer to a parameter being within 10%, optionally less than 5% of its stated value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An electromagnetic component, comprising:
a winding; and
a plurality of distributed winding capacitances in series with the winding at respective locations along the winding.

2. The electromagnetic component of claim 1, wherein the plurality of distributed winding capacitances comprises a first distributed winding capacitance coupled in series between a first portion of the winding and a second portion of the winding and a second distributed winding capacitance coupled in series between the second portion of the winding and a third portion of the winding.

3. The electromagnetic component of claim 2, wherein the second portion of the winding comprises less than or equal to one turn of the winding.

4. The electromagnetic component of claim 2, wherein the second portion of the winding comprises more than one turn of the winding.

5. The electromagnetic component of claim 4, wherein the winding is formed in a plurality of layers, the first portion of the winding comprises a first plurality of turns in a first layer, and the second portion of the winding comprises a second plurality of turns in a second layer.

6. The electromagnetic component of claim 1, wherein at least some of the plurality of distributed winding capacitances are not directly connected to a terminal of the winding.

7. The electromagnetic component of claim 1, wherein the plurality of distributed winding capacitances comprises at least one standalone capacitor.

8. The electromagnetic component of claim 1, wherein the winding includes a thin layer conductor.

9. The electromagnetic component of claim 1, wherein the winding is formed in a plurality of layers.

10. The electromagnetic component of claim 1, wherein the winding is formed in a plurality of turns.

11. The electromagnetic component of claim 10, further comprising a plurality of gaps, wherein at least one of a respective gap of the plurality of gaps is disposed between at least one of a respective turn of the plurality of turns.

12. The electromagnetic component of claim 1, wherein the winding includes wire.

13. The electromagnetic component of claim 12, wherein the wire includes litz wire.

14. The electromagnetic component of claim 12, wherein the wire includes magnet wire.

15. The electromagnetic component of claim 1, further comprising a magnetic core electromagnetically coupled to the winding.
